(19) United States
(12) Patent Application Publication
(10) Pub. No.: US 2026/0301291 A1
(43) Pub. Date: Oct. 1, 2026

(54) Parameterizing Stylized Avatars

(71) Applicant: Meta Platforms Technologies, LLC, Menlo Park, CA (US)

(72) Inventors: Xiaobo AN, London (GB); Gabriele PELLEGRINI, London (GB); John KAHWATY, Montverde, FL (US); Sergi CABALLER GARCIA, Santa Clarita, CA (US)

(21) Appl. No.: 19/545,527

(22) Filed: Feb. 20, 2026

Related U.S. Application Data
(60) Provisional application No. 63/779,023, filed on Mar. 27, 2025.

(51) Int. Cl. G06T 13/40; G06T 17/00

(52) U.S. Cl. CPC G06T 13/40; G06T 17/00

(57) ABSTRACT

Aspects of the present disclosure are directed to parameterizing stylized avatars according to a specific design language. According to certain aspects of the present disclosure, a stylistic framework (e.g., design language) may be defined for avatars associated with a computing platform (e.g., a video game, social media, or extended reality platform). A set of testing avatars may be randomly generated. Measurements of anatomical features (e.g., eye, ear, nose, lips) of each testing avatar of the random set may be determined. A subset of the random set may be determined, wherein the measurements of each testing avatar of the subset may conform to the stylistic framework. Based on the measurements that conform to the stylistic framework, a set of constraints (e.g., lengths, angles, proportions, or ranges thereof) may be determined for generating avatars associated with the computing platform.

### CROSS-REFERENCE TO RELATED APPLICATIONS

This application claims priority to U.S. Provisional Patent Application No. 63/779,023, titled "Parameterizing Stylized Avatars," filed Mar. 27, 2025, which is herein incorporated by reference in its entirety.

### TECHNICAL FIELD

The present disclosure is directed to digital avatar design. More particularly, the present disclosure relates to generating a parameterized set of attributes to create a diverse range of digital avatars that adhere to a predefined design aesthetic.

### BACKGROUND

Avatars serve as virtual representations of users, allowing users to express themselves or engage with others in extended reality spaces. As a result, numerous avatar creation tools and platforms have been developed, enabling users to customize avatars of the user by adjusting various features, such as facial expressions, body shapes, clothing, or accessories.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an extended reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for parameterizing stylized avatars.

FIGS. 6A–6J illustrate example measurements taken on testing avatars for creating avatars that adhere to a given stylistic framework.

FIGS. 7A and 7B illustrate an example set of rules or constraints defined for a given stylistic framework.

The techniques introduced here may be better understood by referring to the following Detailed Description in conjunction with the accompanying drawings, in which like reference numerals indicate identical or functionally similar elements.

### DETAILED DESCRIPTION

Avatar customization options often lack cohesion and consistency, leading to avatars that may not align with the intended visual style or design language of a platform or a larger creative ecosystem.

Aspects of the present disclosure are directed to parameterizing stylized avatars according to a specific design language. According to certain aspects of the present disclosure, a stylistic framework (e.g., design language) may be defined for avatars associated with a computing platform (e.g., a video game, social media, or extended reality platform). A set of testing avatars may be randomly generated. Measurements of anatomical features (e.g., eye, ear, nose, lips) of each testing avatar of the random set may be determined. A subset of the random set may be determined, wherein the measurements of each testing avatar of the subset may conform to the stylistic framework. Based on the measurements that conform to the stylistic framework, a set of constraints (e.g., lengths, angles, proportions, or ranges thereof) may be determined for generating avatars associated with the computing platform.

Avatars serve as virtual representations of users, allowing users to express themselves or engage with others in extended reality spaces. As a result, numerous avatar creation tools and platforms have been developed, enabling users to customize avatars of the user by adjusting various features, such as facial expressions, body shapes, clothing, or accessories. However, customization options often lack cohesion and consistency, leading to avatars that may not align with the intended visual style or design language of a platform or a larger creative ecosystem.

Traditional avatar creation methods rely on either highly detailed, manual customization processes or on automated systems with limited aesthetic coherence. While these tools provide a degree of flexibility, the tools often struggle to maintain consistency in terms of design, leading to fragmented or mismatched avatars that may not align with a desired visual identity. In many cases, this lack of standardization makes it challenging to create avatars that fit within a specific artistic vision, particularly when multiple avatars must be generated for larger digital projects or communities.

Furthermore, in industries such as gaming, entertainment, or extended reality, there is a growing need for scalable, efficient solutions to generate avatars that are not only customizable but also adhere to a particular design language. Herein, a design language may refer to a system of visual principles, characteristics, or stylistic elements that guide the creation of digital content, ensuring a unified aesthetic across all assets. For example, a design language may include minimalist, realistic, cartoonish, or futuristic styles, each with distinct visual features or characteristics. Design languages may help ensure that avatars and other digital elements remain consistent, creating a cohesive and immersive experience for users.

As disclosed herein, novel systems and methods provide for parameterizing stylized avatars according to a specific design language, enabling the efficient generation of cohesive, customizable avatars that align with a predefined visual aesthetic. By defining a set of adjustable parameters, avatars with varying levels of personalization may be generated while ensuring consistency with a particular artistic aesthetic.

Example applications may include video games, social media platforms, extended reality environments, or other interactive digital spaces, where large numbers of avatars must be created and maintained within a consistent design framework. According to systems and methods disclosed herein, users may scale avatar creation processes efficiently while ensuring that the avatars remain visually coherent and aligned with a desired aesthetic.

According to some embodiments, a stylistic framework (e.g., design language) may be defined for avatars associated with a computing platform (e.g., a video game, social media, or extended reality platform). A random set of testing avatars may be generated. Multiple measurements of anatomical features of each testing avatar of the random set may be determined. A subset of the random set may be determined, wherein the multiple measurements of each testing avatar of the subset may conform to the stylistic framework. Based on the multiple measurements that conform to the stylistic framework, a set of constraints may be determined for generating the avatars associated with the computing platform. In some aspects of the embodiments, the stylistic framework may include multiple stylistic guidelines. In some aspects of the embodiments, the multiple measurements of each testing avatar of the subset may conform to one or more of the multiple stylistic guidelines. In some aspects of the embodiments, the multiple measurements of each testing avatar of the subset may conform to each stylistic guideline of the multiple stylistic guidelines. In some aspects of the embodiments, the anatomical features of each testing avatar may include anatomical features of a head of each testing avatar.

Embodiments of the disclosed technology may include or be implemented in conjunction with an extended reality system. Extended reality, artificial reality, or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Extended reality content may include completely generated content or generated content combined with captured content (e.g., real-world photographs). The extended reality content may include video, audio, haptic feedback, or some combination thereof, any of which may be presented in a single channel or in multiple channels (such as stereo video that produces a three-dimensional effect to the viewer). Additionally, in some embodiments, extended reality may be associated with applications, products, accessories, services, or some combination thereof, that are, e.g., used to create content in an extended reality and/or used in (e.g., perform activities in) an extended reality. The extended reality system that provides the extended reality content may be implemented on various platforms, including a head-mounted display (HMD) connected to a host computer system, a standalone HMD, a mobile device or computing system, a "cave" environment or other projection system, or any other hardware platform capable of providing extended reality content to one or more viewers.

"Virtual reality" or "VR," as used herein, refers to an immersive experience where a user's visual input is controlled by a computing system. "Augmented reality" or "AR" refers to systems where a user views images of the real world after they have passed through a computing system. For example, a tablet with a camera on the back can capture images of the real world and then display the images on the screen on the opposite side of the tablet from the camera. The tablet can process and adjust or "augment" the images as they pass through the system, such as by adding virtual objects. "Mixed reality" or "MR" refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Extended reality,” "Artificial reality," "extra reality," or "XR," as used herein, refers to any of VR, AR, MR, or any combination or hybrid thereof.

The disclosed technology provides a specific technological improvement over conventional avatar creation systems. Rather than merely automating an abstract idea of stylistic design, the claimed method is rooted in computer technology to overcome a problem specifically arising in the realm of large-scale digital content generation. Conventional systems lack a technical mechanism to enforce artistic cohesion across thousands or millions of user-generated avatars, leading to inefficient manual review processes or inconsistent visual experiences that degrade the functioning of the computing platform. The disclosed invention improves the functioning of the computer itself by transforming subjective artistic principles into a set of objective, machine-enforceable mathematical constraints. By programmatically generating a dataset of avatars, measuring their features, filtering them against a stylistic framework, and deriving a set of parameter ranges, the system creates a technical tool that enables the computer to automatically generate aesthetically-consistent avatars at scale. This improves the computer's efficiency as a content generation platform, reduces computational resources wasted on generating non-conforming assets, and provides a concrete technical solution to the computer-centric problem of maintaining a unified design language in a dynamic digital environment.

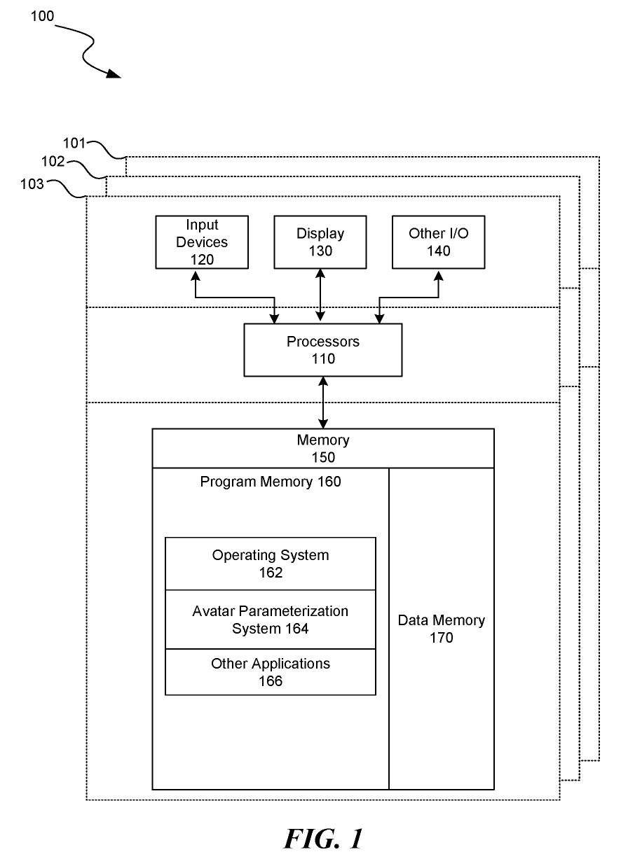

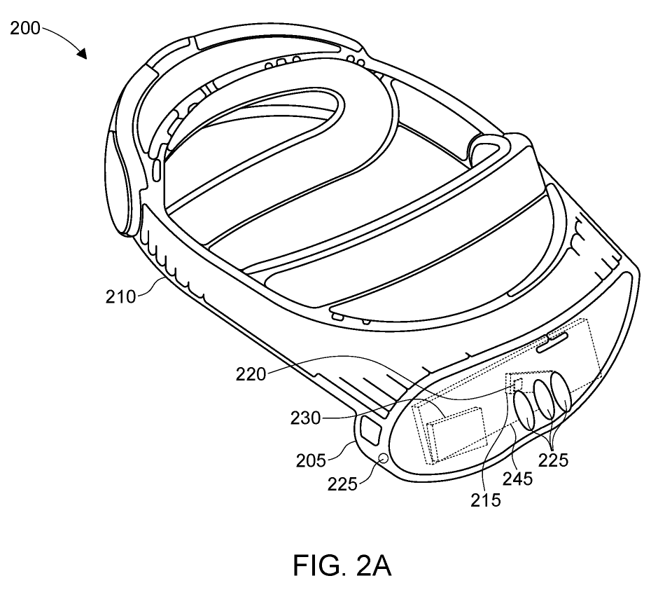

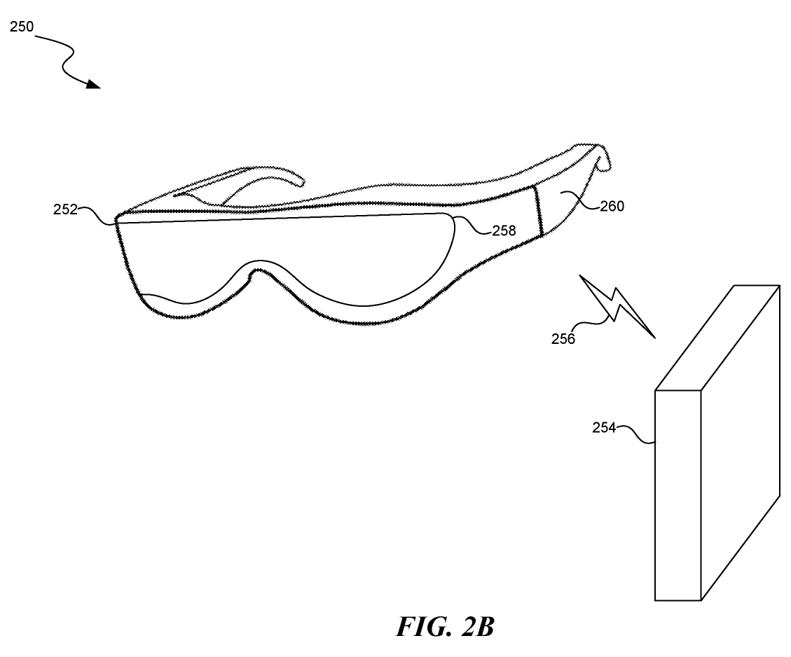

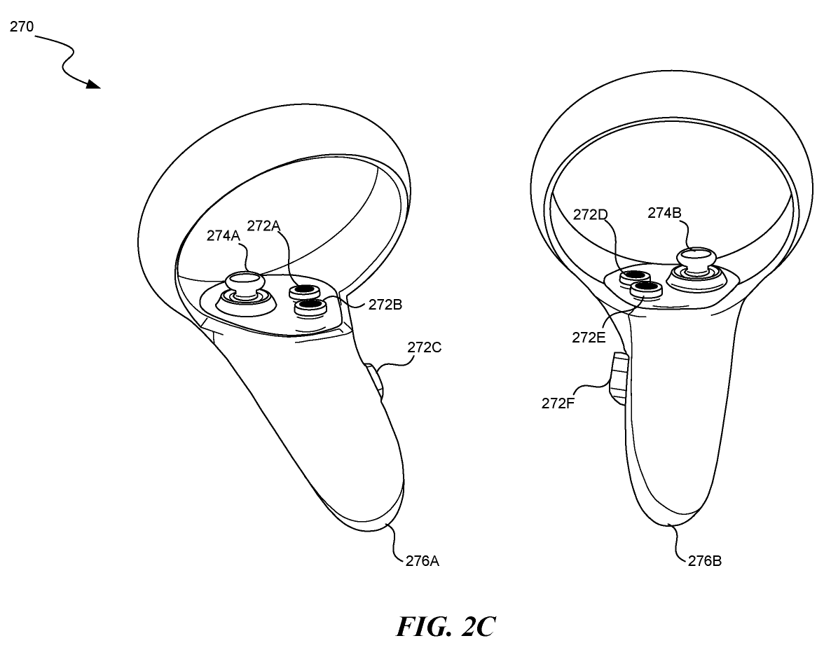

Several implementations are discussed below in more detail in reference to the figures. FIG. 1 is a block diagram illustrating an overview of devices on which some implementations of the disclosed technology can operate. The devices can comprise hardware components of a computing system 100 that parameterize stylized avatars. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, avatar parameterization system 164, and other application programs 166. Memory 150 can also include data memory 170 that can include, e.g., avatar parameters or constraints, stylistic framework details, testing avatars, avatar feature measurements, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to perform steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an extended reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200. In some implementations, cameras 225 can also capture images of parts of the user, such as hands, feet, or other body parts, and use these images to track the position of these body parts. In some cases, this hand / body tracking can be performed in addition or alternatively by worn devices, such as a wrist band, ring, glove, etc. Addition details on user tracking are provided below in relation to FIG. 2C.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. In some implementations, the cameras can capture images of parts of the user, such as hands, feet, or other body parts, and use these images to track the position of these body parts. In some cases, this hand / body tracking can be performed in addition or alternatively by worn devices, such as a wrist band, ring, glove, etc. Addition details on user tracking are provided below in relation to FIG. 2C.

FIG. 2C illustrates controllers 270 (including controller 276A and 276B), which, in some implementations, a user can hold in one or both hands to interact with an extended reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction. In some implementations, images captured of the of the user’s hands can be used to determine a pose and/or position of the hands, which can then be translated to user input and/or to control position or pose of an avatar representing the user in an extended reality environment. For example, various machine learning systems (e.g., trained using synthetic hand pose/position and location information or trained using hand images paired with pose and position data from other tracking devices such as external cameras or tracking sensors) can receive image representations and translate them into hand pose and/or position information. In some implementations, one or more other controllers shapes and configurations can also be used, such as a wrist worn band that translates electrical signals projected into the user’s wrist and then read to interpret a hand pose. For example, such electrical signals can be interpreted by a machine learning system that has been trained using such read electrical signals paired with poses determined by a worn glove or other pose data. In some implementations, such a band can also include various tracking systems, such as an IMU unit, cameras for inside-out tracking, etc.

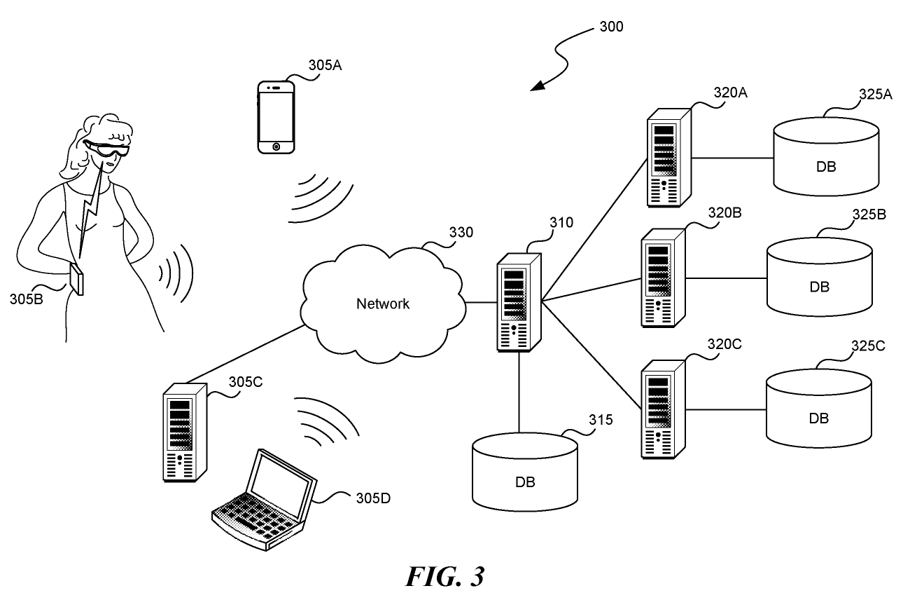

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

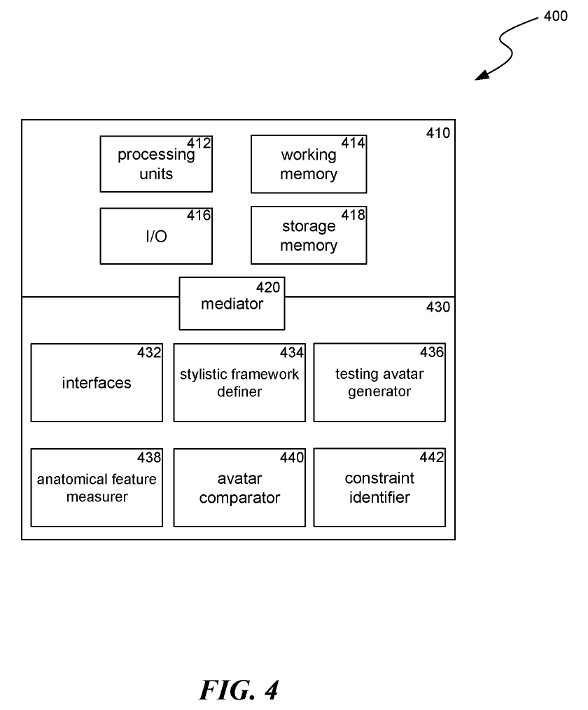

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for parameterizing stylized avatars. Specialized components 430 can include a stylistic framework definer 434, a testing avatar generator 436, an anatomical feature measurer 438, an avatar comparator 440, a constraint identifier 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

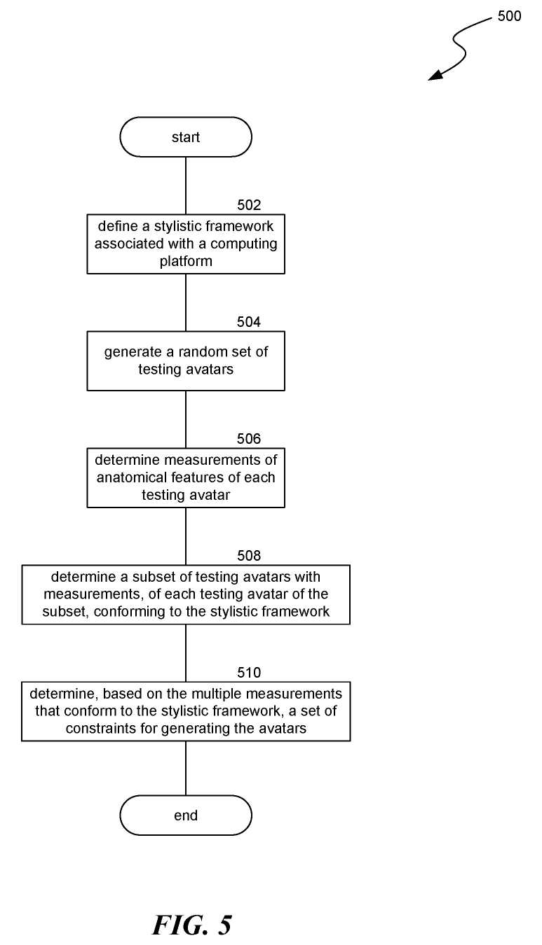

The stylistic framework definer 434 is configured to receive and store the artistic design language that serves as the aesthetic standard for the avatars. This framework can be populated by an artist or designer and includes one or more stylistic guidelines defining attributes such as facial proportions, shape language, and feature alignment. The module acts as the source of truth for the target aesthetic, providing the foundational criteria against which generated avatars are evaluated. Additional details for component stylistic framework definer 434 can be found below with reference to block 502 of FIG. 5.

The testing avatar generator 436 is configured to programmatically create a large and diverse population of testing avatars. Each avatar is generated with a unique combination of randomized anatomical features, ensuring the initial dataset covers a broad spectrum of possible designs. This process is essential for providing a comprehensive set of data points from which the system can later derive the stylistic constraints. Additional details for component testing avatar generator 436 can be found below with reference to block 504 of FIG. 5.

The anatomical feature measurer 438 is configured to programmatically quantify the anatomical characteristics of each testing avatar. This module analyzes the geometry of each avatar to calculate specific measurements, such as distances between facial landmarks, angles of features like the eyes, and proportional ratios between different parts of the face. This systematically transforms the visual representation of each avatar into a structured set of numerical data for subsequent analysis. Additional details for component anatomical feature measurer 438 can be found below with reference to block 506 of FIG. 5.

The avatar comparator 440 is configured to filter the randomly generated population of avatars to identify a subset that conforms to the stylistic framework. This selection process may be performed by an artist manually identifying avatars that meet the desired aesthetic, or it may be automated based on an initial set of rules. The primary function of this module is to isolate the measurement data associated with these "artistically approved" avatars. This curated data forms the validated basis for deriving the final, objective constraints. Additional details for component avatar comparator 440 can be found below with reference to block 508 of FIG. 5.

The constraint identifier 442 is configured to determine a final set of mathematical constraints by analyzing the measurements from the conforming subset of avatars. The module identifies the acceptable value ranges, ratios, and thresholds that are characteristic of the target aesthetic. These derived constraints are the key technical output of the system, providing a machine-enforceable rule set that governs all future avatar generation and customization to ensure stylistic consistency. Additional details for component constraint identifier 442 can be found below with reference to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for parameterizing stylized avatars. In some implementations, process 500 can be performed as a response to a user request or as an automated process built into another process for defining a stylistic framework. In some implementations, process 500 can be performed ahead of time e.g., on a schedule or when servers are determined to have available processing capacity.

At block 502, process 500 defines a stylistic framework for avatars associated with a computing platform. This framework serves as the design language or artistic standard that all generated avatars should adhere to. The framework may be created by an artist or designer and can include multiple stylistic guidelines. These guidelines can specify rules for proportions, such as the "1/3 rule" for vertical or horizontal facial divisions, as well as rules for shape language, color palettes, spacing between features, and other aesthetic attributes. For example, the framework may specify that avatars should have a "planar" or "chiseled" look, characterized by a balance of soft and sharp transitions between facial planes. The framework can be stored in data memory 170 for access by the avatar parameterization system 164.

At block 504, process 500 generates a random set of testing avatars. This step creates a large and diverse population of digital avatars, each with a unique combination of randomly generated anatomical features. The testing avatar generator 436 can be configured to produce a wide variance in features to ensure the initial dataset covers a broad spectrum of possible avatar designs. These testing avatars serve as the raw data for the parameterization process.

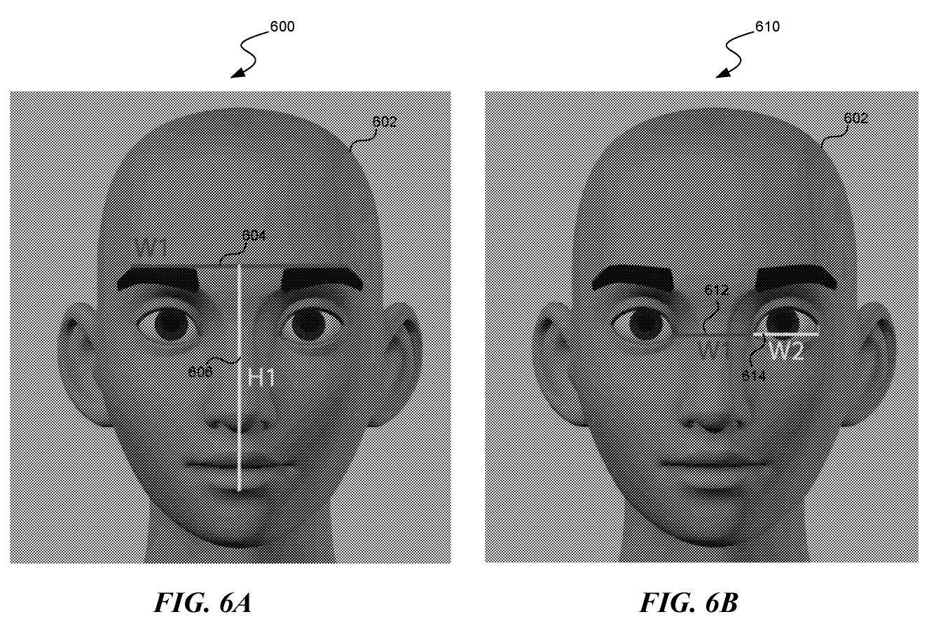

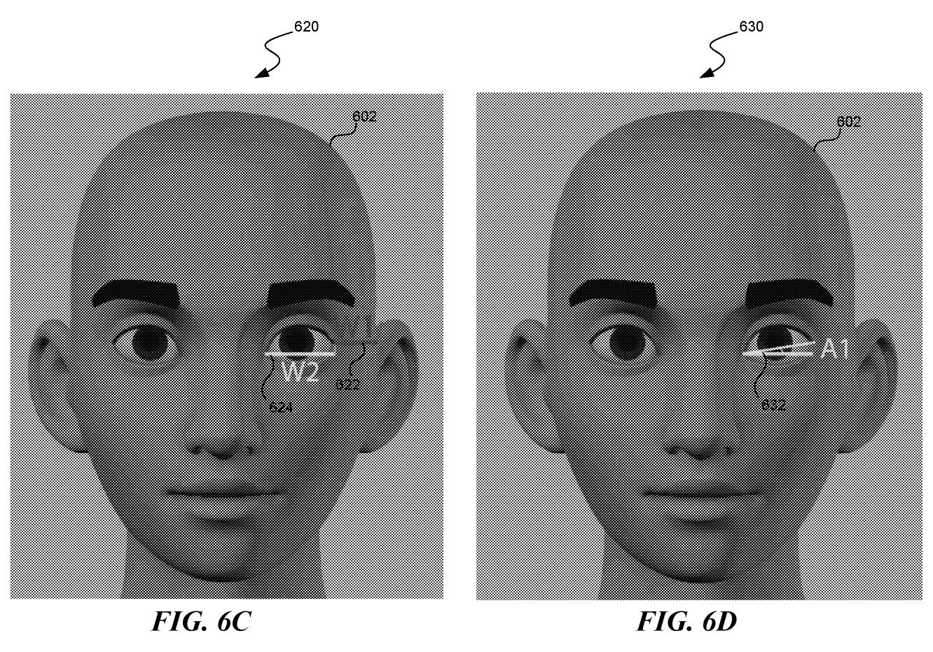

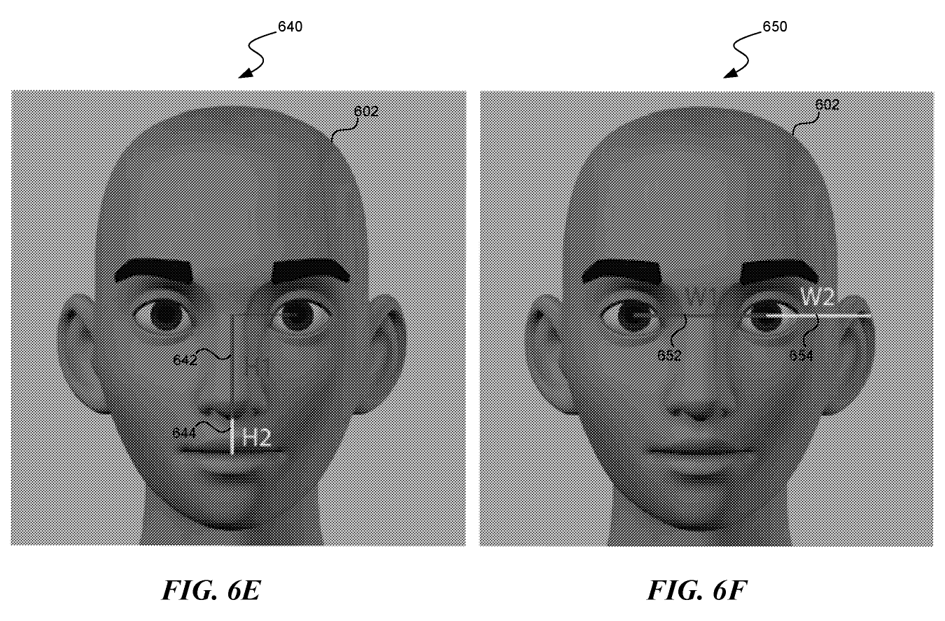

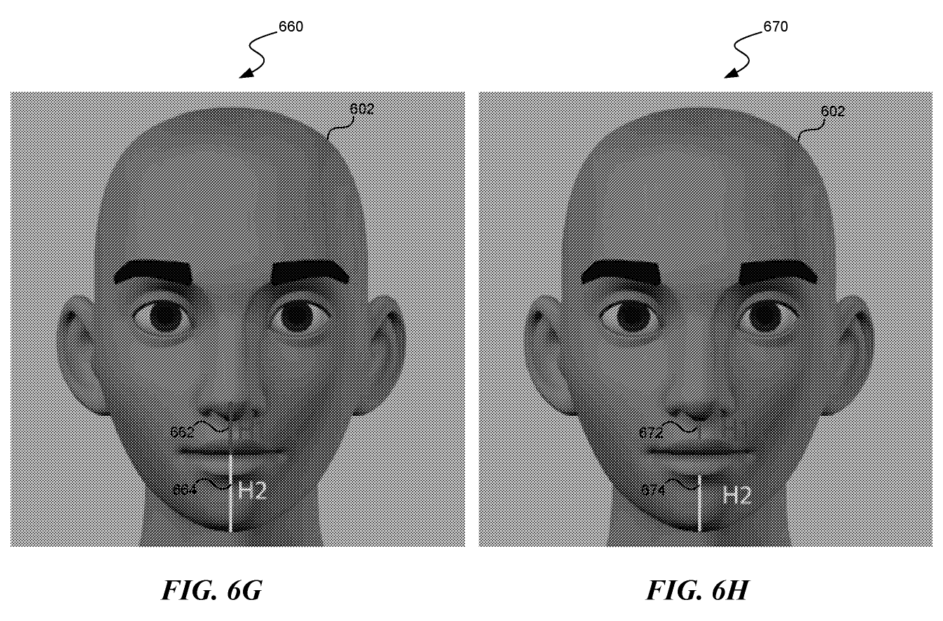

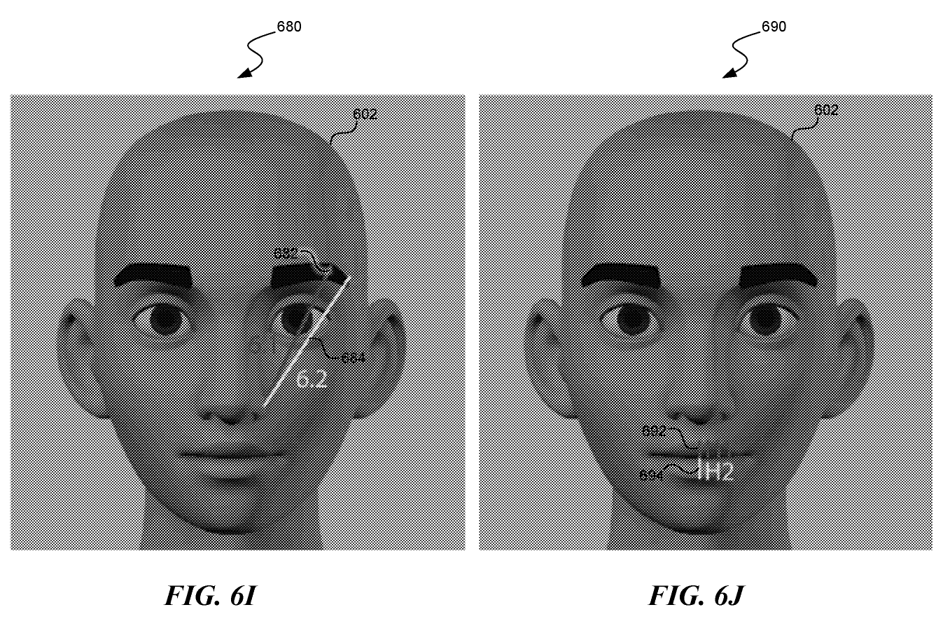

At block 506, process 500 determines multiple measurements of anatomical features of each testing avatar from the random set. The anatomical feature measurer 438 programmatically analyzes each avatar and quantifies various features. These features primarily include anatomical features of the head of each testing avatar. As illustrated in FIGS. 6A-6J, these measurements can include distances, angles, and ratios. For example, as shown in FIG. 6A, the system can measure the distance H1 between the brow line 604 and the bottom of the lower lip 606, and the distance W1 between the highest points of the two brows. In another example shown in FIG. 6D, the system can measure the angle of eye rotation A1632. In other implementations, measurements can include proportions, such as the ratio of nose width to mouth width, or the thickness of the upper lip relative to the lower lip as shown in FIG. 6J. All these measurements are stored as data associated with each testing avatar.

At block 508, process 500 determines a subset of testing avatars from the random set, wherein the multiple measurements of each testing avatar in the subset conform to the stylistic framework. The avatar comparator 440 performs this filtering step. In some implementations, an artist or designer may manually review the random set of avatars and select those that visually align with the intended aesthetic of the stylistic framework. In other implementations, the avatar comparator 440 may apply a preliminary set of rules to automatically identify the conforming subset. The key outcome of this step is the isolation of a group of "artistically approved" avatars and their associated measurement data. For example, the subset may be selected because their measurements conform to one or more of the multiple stylistic guidelines, or to each stylistic guideline of the multiple stylistic guidelines.

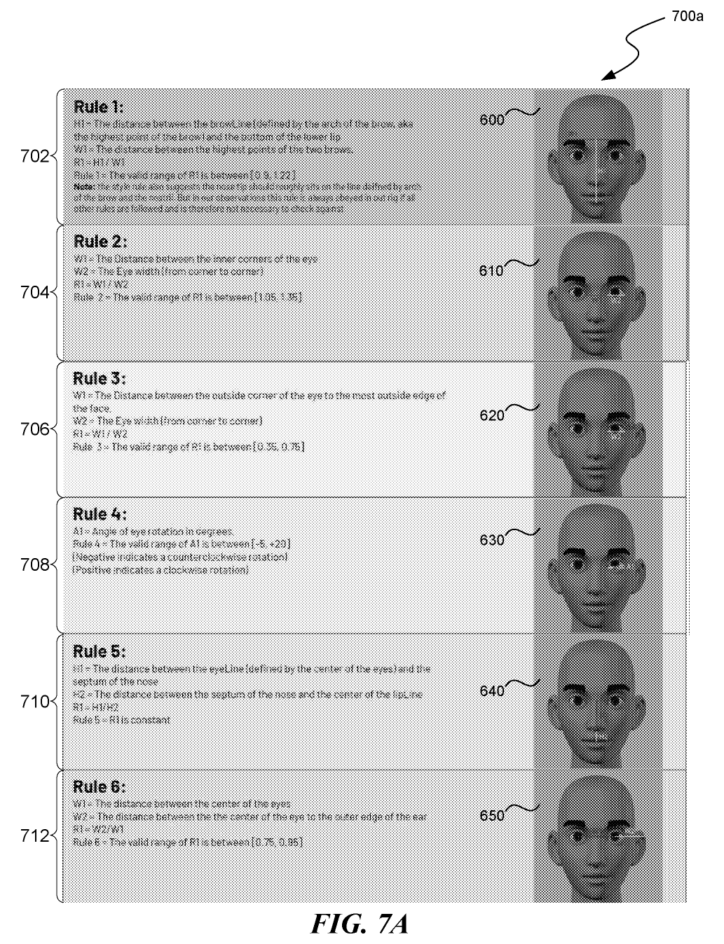

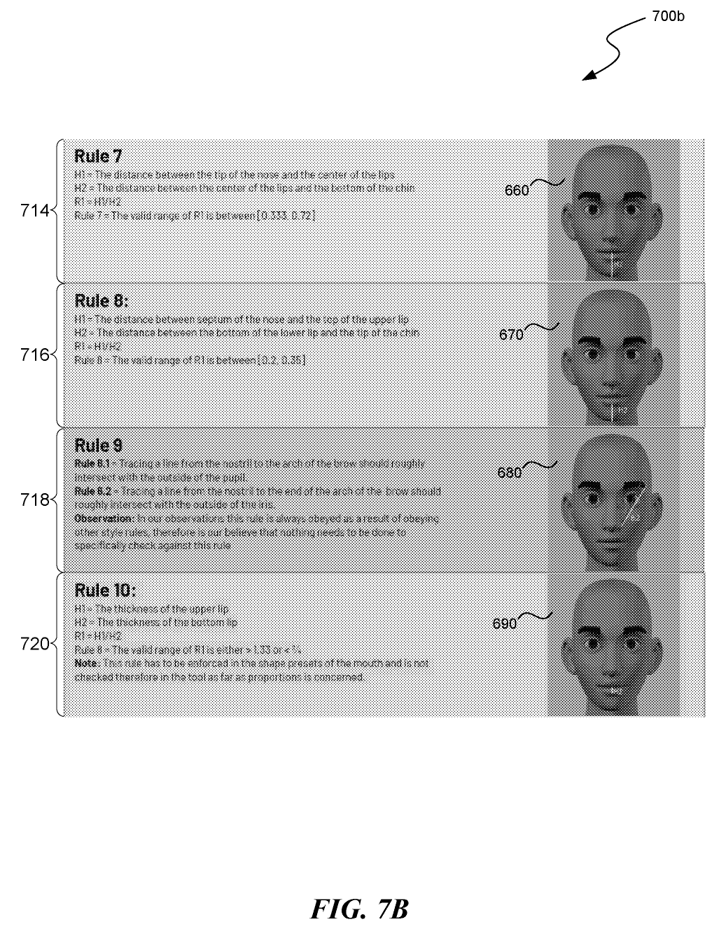

At block 510, process 500 determines, based on the multiple measurements that conform to the stylistic framework, a set of constraints for generating avatars. The constraint identifier 442 analyzes the measurement data from the conforming subset of avatars identified in block 508. By analyzing the commonalities and acceptable ranges within this "approved" data, the system derives a set of mathematical constraints. These constraints represent the objective, machine-enforceable translation of the subjective stylistic framework. For instance, as illustrated in FIGS. 7A and 7B, the system might determine that for all conforming avatars, the ratio of eye width to the distance between the eyes falls within a specific range (e.g., Rule 2, 704). Another constraint might define the acceptable range for the angle of eye rotation (e.g., Rule 4, 708). This final set of constraints is then used by the avatar generation system to ensure that any newly created or customized avatar automatically adheres to the predefined design language.

FIGS. 6A-6J illustrate various example measurements that can be taken on the head 602 of a testing avatar, e.g., by the anatomical feature measurer 438.

FIG. 6A illustrates a first set of measurements 600 taken on the head 602 of a testing avatar. A first measurement determines the horizontal distance 604 between the highest points of the two brows. A second measurement 606 measures the vertical distance between a horizontal line passing through the arch of the brows between the bottom of the lower lip and up to brow line 604. These two measurements can be used to calculate a proportional ratio for a constraint in the stylistic framework.

FIG. 6B illustrates a second set of measurements 610 related to the eyes of the head 602. A first measurement 612 determines the horizontal distance W1 between the inner corners of the eyes. A second measurement 614 determines the width W2 of an eye, measured from its inner corner to its outer corner. In some implementations, measurement 614 can be an average of this measurement for both the eyes in head 602. The relationship between these measurements 612 and 614 can define spacing and proportion for the eyes relative to each other.

FIG. 6C illustrates a third set of measurements 620 related to the placement of the eyes on the head 602. A first measurement 622 determines the horizontal distance W1 from the outer corner of an eye to the corresponding outermost edge of the face. A second measurement 624 determines the width W2 of the eye itself, measured from its inner corner to its outer corner 624 (which can be measurement 614). This allows the system to quantify how the eyes are positioned relative to the edge of the head.

FIG. 6D illustrates measurement 630 taken on the head 602. This measurement determines the angle 632 of eye rotation A1, which represents the tilt or inclination of the eye relative to a true horizontal axis. This angle can be measured in degrees, with positive values indicating a clockwise rotation and negative values indicating a counter-clockwise rotation, thereby defining an expressive characteristic of the avatar's face.

FIG. 6E illustrates a fourth set of measurements 640 for defining vertical proportions in the central facial region of the head 602. A first measurement 642 determines the vertical distance H1 between a horizontal line connecting a point at a height of the center of the iris to a point at the bottom of the nose. A second measurement 644 determines the vertical distance H2 between the point at the bottom of the nose and the connection point between the lips. These measurements can establish the proportional balance between the upper and middle sections of the face.

FIG. 6F illustrates a fifth set of measurements 650 for defining horizontal proportions of the head 602. A first measurement 652 determines the distance W1 between the centers of the eyes, referred to as the interpupillary distance. A second measurement 654 determines the distance W2 from the center of an eye to the outer edge of the corresponding ear. The these distances can establish a balanced and aesthetically pleasing head shape according to the stylistic framework.

FIG. 6G illustrates a sixth set of measurements 660 for defining proportions in the lower facial region of the head 602. A first measurement 662 determines the vertical distance H1 between the tip of the nose and the point where the lips meet. A second measurement 664 determines the vertical distance H2 between the point where the lips meet and the bottom of the chin. These measurements can govern the relative positioning of the mouth and chin.

FIG. 6H illustrates a seventh set of measurements 670 that further define proportions in the lower facial region of the head 602. A first measurement 672 determines the vertical distance H1 between the septum of the nose and the top of the upper lip. A second measurement 674 determines the vertical distance H2 between the bottom of the lower lip and the tip of the chin. These measurements can provide granular detail on the spacing around the mouth area.

FIG. 6I illustrates a set of alignment-based measurements 680 on the head 602. A first alignment measurement 682 is determined by a line 6.1 traced from the rightmost point of the nostril to the arch of the brow. A second alignment measurement 684 is determined by a line 6.2 from the rightmost point of the nostril to the rightmost point of the brow. These geometric relationships can control facial features to make them are harmoniously aligned.

FIG. 6J illustrates an eighth set of measurements 690 related to the lips on the head 602. A first measurement 692 determines the vertical thickness H1 of the upper lip. A second measurement 694 determines the vertical thickness H2 of the bottom lip. The these thicknesses can be used to ensure the lips have a non-uniform, interesting shape that conforms to the stylistic framework.

FIGS. 7A and 7B illustrate an example set of rules or constraints 700a and 700b, e.g., derived by the constraint identifier 442, from the measurements of conforming avatars. These rules define the objective parameters determined for the example stylistic framework.

Rule 1, as shown at 702, establishes a constraint on the overall vertical proportion of the central facial features. It is based on the measurements 600 from FIG. 6A, calculating a ratio (R1) between the vertical distance H1604 (from the brow line to the bottom of the lower lip) and the horizontal distance W1606 (between the highest points of the brows). To conform to the example stylistic framework, this ratio R1 must fall within the range of [0.9, 1.22].

Rule 2, as shown at 704, defines a constraint on the spacing between the eyes. It is based on the measurements 610 from FIG. 6B, calculating a ratio (R1) between the distance W1612 (between the inner corners of the eyes) and the eye width W2614. This rule dictates that for an avatar to be stylistically conforming, the distance between the eyes must be proportionally larger than the width of a single eye, with the valid range for the ratio R1 being between [1.05, 1.35].

Rule 3, as shown at 706, defines a constraint on the spacing from the outer corner of the eye to the edge of the face. It is based on the measurements 620 from FIG. 6C, calculating a ratio (R1) between the distance W1622 (from the outer eye corner to the edge of the face) and the eye width W2624. This constraint ensures the eyes are not positioned too close to the sides of the head, with the valid range for the ratio R1 being between [0.35, 0.75].

Rule 4, as shown at 708, establishes a constraint on the rotation of the eyes. This rule is based on the angular measurement 630 from FIG. 6D, which determines the angle 632 of eye rotation A1. The stylistic framework requires this angle to be within the range of [-5, +20] degrees, where a positive value indicates a clockwise rotation and a negative value indicates a counter-clockwise rotation. This prevents extreme eye angles that would deviate from the desired aesthetic.

Rule 5, as shown at 710, defines a constraint on the vertical positioning of the nose relative to the eyes and mouth. It is based on the measurements 640 from FIG. 6E, calculating a ratio (R1) between the distance H1642 (from the eyeline to the septum) and the distance H2644 (from the septum to the lip line). The rule specifies that this ratio R1 is constant, meaning this proportional relationship is a fixed aspect of the stylistic framework.

Rule 6, as shown at 712, establishes a constraint on the horizontal width of the head relative to the eye spacing. It is based on the measurements 650 from FIG. 6F, calculating a ratio (R1) between the distance W2654 (from the center of an eye to the outer edge of the ear) and the distance W1652 (between the centers of the eyes). To conform to the style, this ratio must fall within the range of [0.75, 0.95].

Rule 7, as shown at 714, defines a constraint on the proportions of the lower part of the face. It is based on the measurements 660 from FIG. 6G, calculating a ratio (R1) between the distance H1662 (from the nose tip to the center of the lips) and the distance H2664 (from the center of the lips to the bottom of the chin). The valid range for this ratio is specified as being between [0.333, 0.72], ensuring a balanced lower facial structure.

Rule 8, as shown at 716, provides a more granular constraint on the area around the mouth. It is based on the measurements 670 from FIG. 6H, calculating a ratio (R1) between the distance H1672 (from the septum to the top of the upper lip) and the distance H2674 (from the bottom of the lower lip to the tip of the chin). The valid range for this ratio is specified as being between [0.2, 0.35], controlling the vertical placement of the mouth.

Rule 9, as shown at 718, relates to the harmonious alignment of facial features, as illustrated in the measurements 680 of FIG. 6I. This rule observes that lines traced from the nostril to the arch and end of the brow should naturally intersect with the pupil and iris, respectively. The framework notes that this alignment is an emergent property that is always obeyed if the other numerical rules are followed, and therefore may not require a separate, explicit check by the system.

Rule 10, as shown at 720, establishes a constraint to prevent unnatural uniformity in lip thickness. It is based on the measurements 690 from FIG. 6J, calculating a ratio (R1) between the thickness of the upper lip H1692 and the thickness of the bottom lip H2694. The rule specifies that this ratio R1 must either be greater than 1.33 or less than 0.75. This disjunctive constraint ensures that one lip is always visibly thicker than the other.

Rules 1-10, when taken together, form the comprehensive set of constraints for generating stylistically consistent avatars for the example stylistic framework.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., "non-transitory" media) and computer-readable transmission media.

Reference in this specification to "implementations" (e.g., "some implementations," "various implementations," “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase "selecting a fast connection" can be understood to mean selecting a connection that has a value assigned corresponding to its connection speed that is above a threshold.

As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A method for parameterizing stylized avatars, the method comprising:
defining a stylistic framework for avatars associated with a computing platform;
generating a random set of testing avatars;
determining multiple measurements of anatomical features of each testing avatar of the random set of testing avatars;
determining a subset of testing avatars, of the random set, wherein determining the subset is performed such that the multiple measurements of each testing avatar of the subset of testing avatars conforms to the stylistic framework;
determining, based on the multiple measurements that conform to the stylistic framework, a set of constraints for generating the avatars associated with the computing platform.

2. The method of claim 1, wherein the stylistic framework includes multiple stylistic guidelines.

3. The method of claim 2, wherein the determining the subset of testing avatars includes selecting testing avatars in the subset such that each testing avatar, in the subset, has each of its multiple measurements conforming to one or more of the multiple stylistic guidelines.

4. The method of claim 3, wherein the selecting testing avatars in the subset is further performed such that for each testing avatar, in the subset, none of the multiple measurements is contrary to one or more of the multiple stylistic guidelines.

5. The method of claim 1, wherein the anatomical features of each testing avatar include anatomical features of a head of each testing avatar.

6. The method of claim 5, wherein the anatomical features, of the head of each testing avatar, include at least one of: a distance between facial features, an angle of a facial feature, a ratio of dimensions of facial features, or any combination thereof.

7. The method of claim 1, wherein the set of constraints includes multiple rules, each rule defining a valid range for a corresponding measurement.

8. A computer-readable storage medium storing instructions, for parameterizing stylized avatars, the instructions, when executed by a computing system, cause the computing system to:
define a stylistic framework for avatars associated with a computing platform;
generate a random set of testing avatars;
determine multiple measurements of anatomical features of each testing avatar of the random set of testing avatars;
determine a subset of testing avatars, of the random set, wherein determining the subset is performed such that the multiple measurements of each testing avatar of the subset of testing avatars conforms to the stylistic framework;
determine, based on the multiple measurements that conform to the stylistic framework, a set of constraints for generating the avatars associated with the computing platform.

9. The computer-readable storage medium of claim 8, wherein the stylistic framework includes multiple stylistic guidelines.

10. The computer-readable storage medium of claim 9, wherein the determining the subset of testing avatars includes selecting testing avatars in the subset such that each testing avatar, in the subset, has each of its multiple measurements conforming to one or more of the multiple stylistic guidelines.

11. The computer-readable storage medium of claim 10, wherein the selecting testing avatars in the subset is further performed such that for each testing avatar, in the subset, none of the multiple measurements is contrary to one or more of the multiple stylistic guidelines.

12. The computer-readable storage medium of claim 8, wherein the anatomical features of each testing avatar include anatomical features of a head of each testing avatar.

13. The computer-readable storage medium of claim 12, wherein the anatomical features, of the head of each testing avatar, include at least one of: a distance between facial features, an angle of a facial feature, a ratio of dimensions of facial features, or any combination thereof.

14. The computer-readable storage medium of claim 8, wherein the set of constraints includes multiple rules, each rule defining a valid range for a corresponding measurement.

15. A computing system for parameterizing stylized avatars, the computing system comprising:
one or more processors; and
one or more memories storing instructions that, when executed by the one or more processors, cause the computing system to:
define a stylistic framework for avatars associated with a computing platform;
generate a random set of testing avatars;
determine multiple measurements of anatomical features of each testing avatar of the random set of testing avatars;
determine a subset of testing avatars, of the random set, wherein determining the subset is performed such that the multiple measurements of each testing avatar of the subset of testing avatars conforms to the stylistic framework;
determine, based on the multiple measurements that conform to the stylistic framework, a set of constraints for generating the avatars associated with the computing platform.

16. The computing system of claim 15,
wherein the stylistic framework includes multiple stylistic guidelines; and
wherein the determining the subset of testing avatars includes selecting testing avatars in the subset such that each testing avatar, in the subset, has each of its multiple measurements conforming to one or more of the multiple stylistic guidelines.

17. The computing system of claim 15,
wherein the anatomical features of each testing avatar include anatomical features of a head of each testing avatar; and
wherein the anatomical features, of the head of each testing avatar, include at least one of: a distance between facial features, an angle of a facial feature, a ratio of dimensions of facial features, or any combination thereof.

18. The computing system of claim 15, wherein a new avatar is generated based on the set of constraints.

19. The computing system of claim 18, wherein the instructions, when executed by the one or more processors, further cause the computing system to:
receive user input to customize the new avatar; and
maintain conformance with the stylistic framework by applying the set of constraints in relation to updating the new avatar.

20. The computing system of claim 15, wherein the computing platform is one of a video game, a social media platform, or an extended reality platform..
